(19) United States
(12) Patent Application Publication
(10) Pub. No.: US 2014/0137987 A1
(43) Pub. Date: May 22, 2014

(54) Jaw Devices for Heavy Equipment

(71) Applicant: Scott Jahn, Terrebonne, OR (US)

(72) Inventor: Scott Jahn, Terrebonne, OR (US)

(21) Appl. No.: 13/679,870

(22) Filed: Nov. 16, 2012

(51) Int. Cl. A01G 23/087; A01G 23/093

(52) U.S. Cl. CPC A01G 23/087; A01G 23/093
USPC 144/339; 144/34.5; 144/3.1; 144/4.1

(57) ABSTRACT

Jaw-type devices are disclosed which are designed to be utilized by heavy equipment, such as tractors, front-loader machines, skid steers, mini track loaders, fork lifts, etc., to grasp, cut, move, lift or otherwise manipulate a variety of objects, such as trees, rocks, hay bales, paper bales, potted plants, etc. The jaw-type devices are configured to be removably attached to a piece of heavy equipment, e.g. through a standard mount such as a three-point hookup or front-loader universal quick attachment plate such as are typically provided on heavy equipment, and to receive a variety of interchangeable attachments.

### BACKGROUND

Heavy machinery implements or attachments allow for application versatility by utilizing the hydraulic and mechanical forces generated by the heavy machine to which they are attached. Some machines, such as a skid steer, tractor or excavator, are designed to utilize a variety interchangeable implements through standardized attachment features, e.g. a three point hookup or a universal attachment system mounted to a hydraulically actuated system, e.g. a front loader. Frequently implements are designed to fulfill specific requirements and particular duties. Implements can constitute a significant investment on the part of the owner, but this cost is acceptable due to the enhanced productivity that the implement provides. Implements include, for example, tree shears and jaws for grasping objects such as rocks.

### SUMMARY

Generally, the present disclosure relates to jaw-type devices designed to be utilized by heavy equipment, such as tractors, front-loader machines, skid steers, mini track loaders, forklifts, etc., to grasp, cut, move, lift or otherwise manipulate a variety of objects, such as trees, rocks, hay bales, paper bales, potted plants, etc.

The jaw-type devices described herein are configured to be removably attached to a piece of heavy equipment, e.g. through a standard mount such as a three-point hookup, a front-loader mount or a universal quick attachment plate such as are typically provided on heavy equipment, such as a skid steer, and to receive a variety of interchangeable attachments.

The term “heavy equipment,” as used herein, refers to heavy duty vehicles that include a power train and hydraulic machinery, and includes, but is not limited to, bulldozers, excavators, track loaders, skidders, telehandlers, tractors, skid steers, graders, harvesters, and the like.

In one aspect, the invention features a device that includes (a) a mount configured to be removably attached to a piece of heavy equipment, (b) a jaw comprising a pair of jaw elements, at least one of which is pivotally attached to the mount, and (c) a force applying element. Each jaw element includes a plate element disposed in the horizontal plane, each of these plate elements having a plurality of attachment points configured to allow an attachment to be removably attached to the plate element. The force applying element is configured to, when actuated, pivot at least one of the jaw elements so as to bring opposing surfaces of the plate elements closer together.

Some implementations include one or more of the following features.

The attachments to be removably attached to the plate elements may be, for example, selected from the group consisting of shearing blades, carriers, crushers, wood splitters, snow plows, sod-unrollers, grapplers, digging tools, ditching tools, and grading tools. In general, the attachments may be, for example, landscape tools, construction tools, excavation tools, or industrial tools. In some cases, the plurality of attachment points may be in the form of multiple holes extending through the plate element in the horizontal plane along at least a portion of the length of the plate element.

The plate elements preferably include a plurality of teeth, which may be disposed along part of or the entire length of an inner edge of each plate element. In some cases, at least some of the teeth are radiused. The teeth may be configured to allow a portion of the plate elements to completely fit together when the jaw is closed. In some cases, the teeth are configured to allow a second portion of the plate elements to remain spaced from each other when the jaw is closed, defining an open area between the plate elements. This may be accomplished, for example, by having relatively larger teeth where the plate elements close together and smaller teeth where they remain spaced apart.

In some implementations, each jaw element comprises a support element on which one of the plate elements is mounted. The support elements may each include a vertical member having a plurality of holes configured to serve as vertical attachment points for the attachment, e.g., if the attachment is heavy or will cantilever out beyond the front of the jaw and thus require further support.

A universal attachment device can in some cases be attached to the plate element, e.g., to allow for quick mounting and removal of the attachment. The universal attachment device may be, for example, a splined collar. The universal attachment device is preferably fixedly mounted to the plate element by welding. Attachment points, e.g., in the form of holes, can be used to add, e.g., by bolting, further device enhancements.

The jaw elements may be configured to allow for an open area between the jaw elements near the jaw pivot point(s) when the jaw elements are closed. This may be accomplished, for example, by shaping the plate elements to provide this open area.

The jaw may be configured so that no aspect of the jaw extends below a lower surface of the plate elements.

In another aspect, the invention features a plate element, for use in a jaw, the plate element including any one or more of the features described above, in any combination.

In a further aspect, the invention features a device that includes (a) a mount configured to be removably attached to a piece of heavy equipment, (b) a jaw comprising a pair of jaw elements, at least one of which is pivotally attached to the mount, each jaw element including a plate element disposed in the horizontal plane, and (c) a force applying element, configured to, when actuated, pivot at least one of the jaw elements so as to bring opposing surfaces of the plate elements closer together. In this aspect, the plate elements are configured so that when the plate elements close together the plate elements define an open area adjacent to the mount.

Some implementations of this aspect include one or more of the following features. Implementations may also include any of the features discussed above.

The open area may be generally oval. The plate elements may include teeth that extend into the open area. The plate elements may include generally triangular protrusions that extend horizontally into the open area to define an end of the open area proximal to the mount. The triangular protrusions are dimensioned to eject, i.e., clear material from the open area of the jaw as the jaw members open.

In another aspect, the invention features a device comprising: a mount configured to be removably attached to a piece of heavy equipment, a jaw comprising a pair of jaw elements, at least one of which is pivotally attached to the mount. Each jaw element includes a truss structure comprising of an upper support member and a lower support member connected by multiple truss webs, and a force applying element, configured to, when actuated, pivot at least one of the jaw elements so as to bring opposing surfaces of the jaw elements closer together.

The invention also features methods of using the devices described herein. For example, in one aspect the invention features a method that includes (a) shearing the trunk of a first tree using a jaw that is mounted on a piece of heavy equipment, the jaw having opposed shearing blades that are mounted on jaw elements, the jaw elements and shearing blades being configured so that when the shearing blades close together an open area is defined at the end of the jaw proximal to the piece of heavy equipment; (b) allowing the trunk of the first sheared tree to move into the opening; and (c) shearing a trunk of a second tree while the first sheared tree remains in the opening.

These steps may be repeated to “accumulate” several trees within the open area of the jaw, to improve productivity when a number of trees are being harvested at once. Thus, for example, the method can further include allowing the trunk of the second sheared tree to move into the open area adjacent the trunk of the first sheared tree, and in some cases shearing the trunk of a third tree while the first and second sheared trees remain in the opening. The method may further include using the jaw to move the first and second sheared trees, and the third sheared tree if present, to a desired location. In addition, similar actions can be used for shearing and manipulating shrubs, bushes, woody debris and other plant types.

### DESCRIPTION OF THE DRAWINGS

FIG. 1 is a perspective view of one embodiment of the device.

FIG. 2 is a perspective view of the jaw elements of the device.

FIG. 3 is a top view of the device with the jaw closed.

FIG. 4 is a top view the device with the jaw open.

FIG. 5 is a top view of the jaw.

FIG. 6 is a side view of a jaw element.

FIG. 7 is a perspective view of an alternate embodiment of the device (with skid plate and without force applying elements).

FIG. 8 is a front view of an alternate embodiment of the device (with protective shroud and without force applying elements).

FIG. 9 is a top view of the device frame.

FIG. 10 is a front view of the device frame.

FIG. 11 is view of an attachment (grapple) interfaced with the splined receiver on the jaws of the device.

FIG. 12 is a view of a grapple attachment.

FIG. 13 is a view of a clamp attachment.

FIG. 14 is a view of an pipe clamp attachment.

### DETAILED DESCRIPTION

Preferred jaw devices include a frame constructed to allow the device to be mounted on a piece of heavy equipment, and a jaw that includes two jaw elements, each of which is strengthened by a truss support structure. The jaw elements are pivotally attached to the frame, and include two plate elements having attachment points (e.g., holes) for mounting either individual attachments or a universal attachment device configured to receive the attachments. Two force applying elements, e.g., hydraulic cylinders, are mounted on the frame and attached to the distal ends of the jaws, so as to apply a force to open and close the jaws.

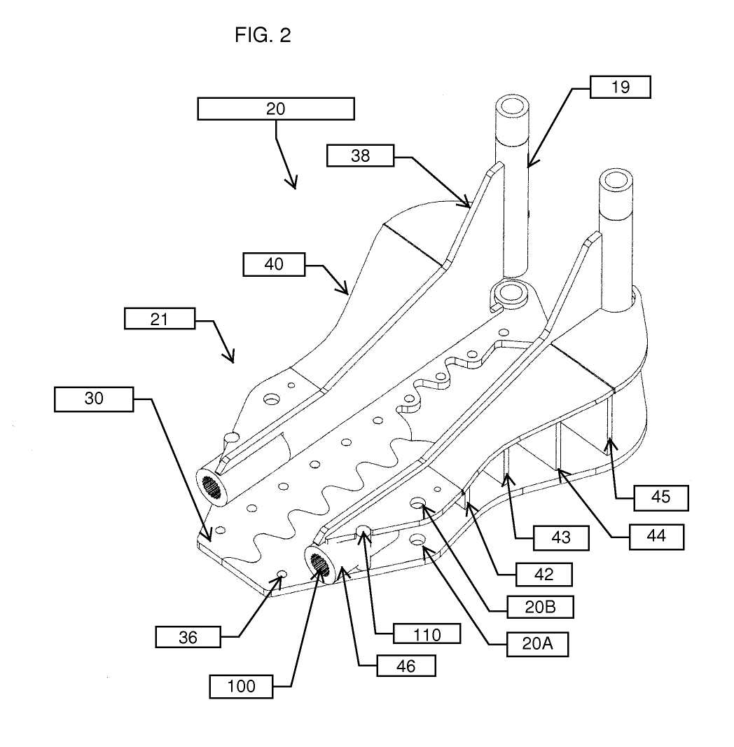

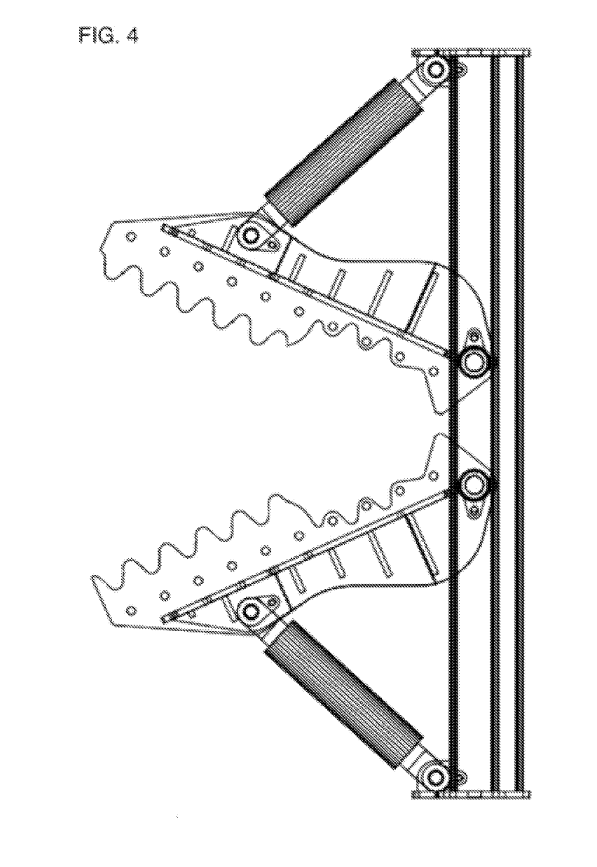

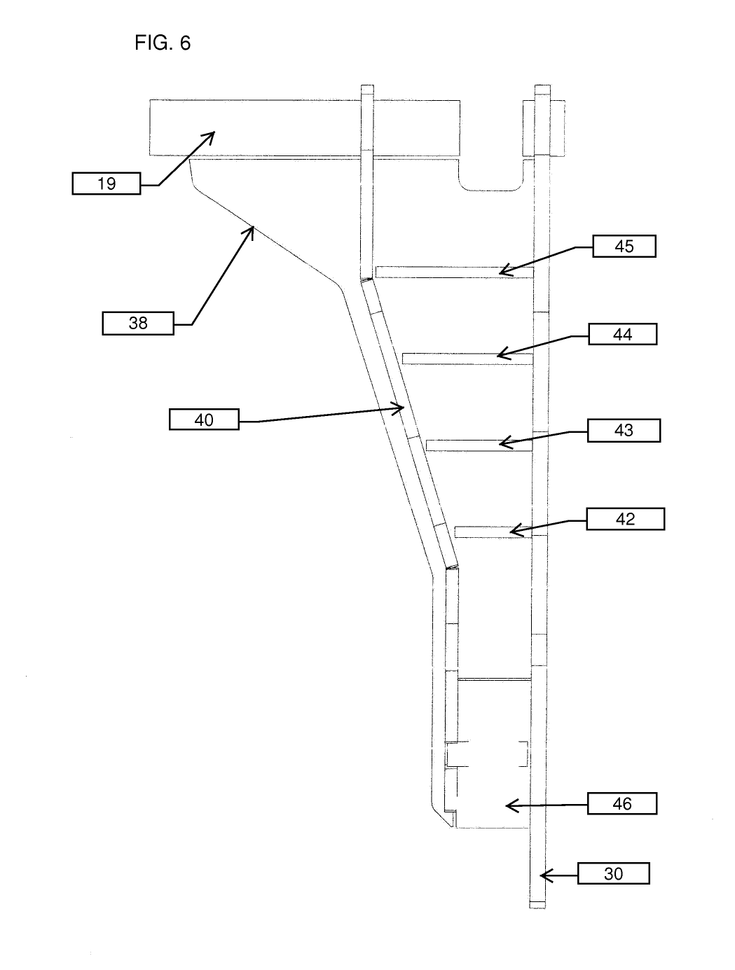

Referring to FIGS. 2 and 6, the jaw 20 comprises two jaw elements 21, each of which comprises a plate element 30, a vertical support element 38, an upper support element 40, and truss elements 42, 43, 44, and 45. The material used for the plate elements may have a thickness of, for example, from about 0.4 inch to about 2.5 inches, depending on the size of the jaw 20 and its intended use. The jaw 20 may have a length, for example, of from about 18 inches to about 70 inches. When the jaw is open (FIG. 4) the distance between the jaw elements 21, measured tip-to-tip, may range from, for example, about 18 inches to about 70 inches.

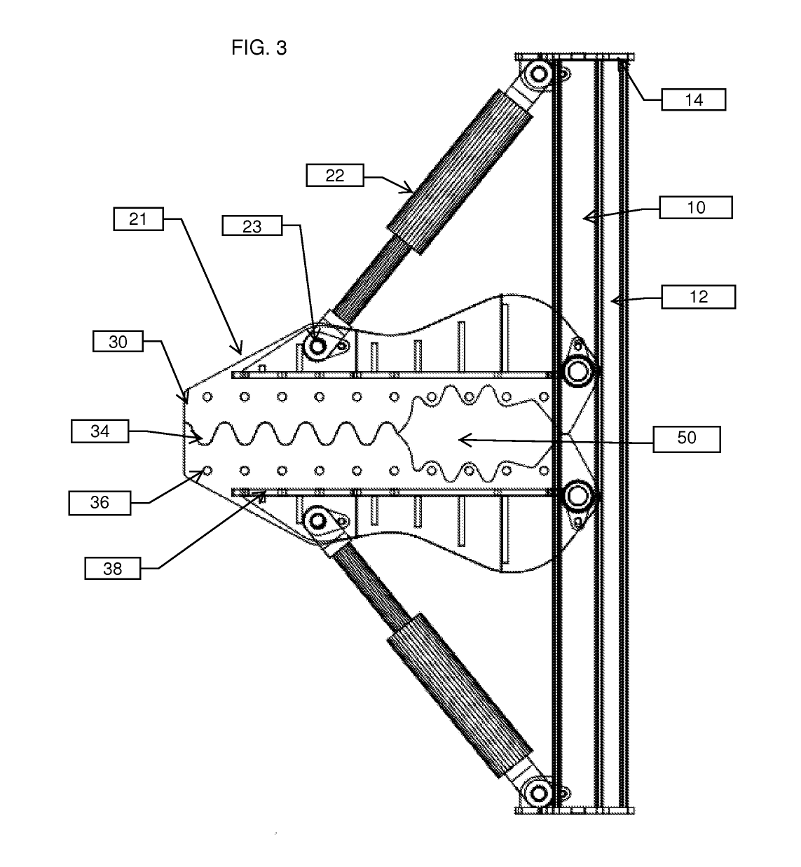

Force applying elements 22, e.g., hydraulic cylinders, are attached to a pair of frame cylinder mounts 16 and to each of the jaw elements 21, and are configured to apply a force generally in the horizontal plane to pivot the jaw elements about pivot pins 19, moving the jaw elements between an open position (FIG. 3) and a closed position (FIG. 4).

As shown in FIG. 2, the truss elements are attached directly to the plate elements, preferably by welding. The support/truss assembly structure provides the jaw element with high strength and resistance to distortion and twisting, as will be discussed in further detail below. The truss structure will be described in further detail below with reference to FIG. 6.

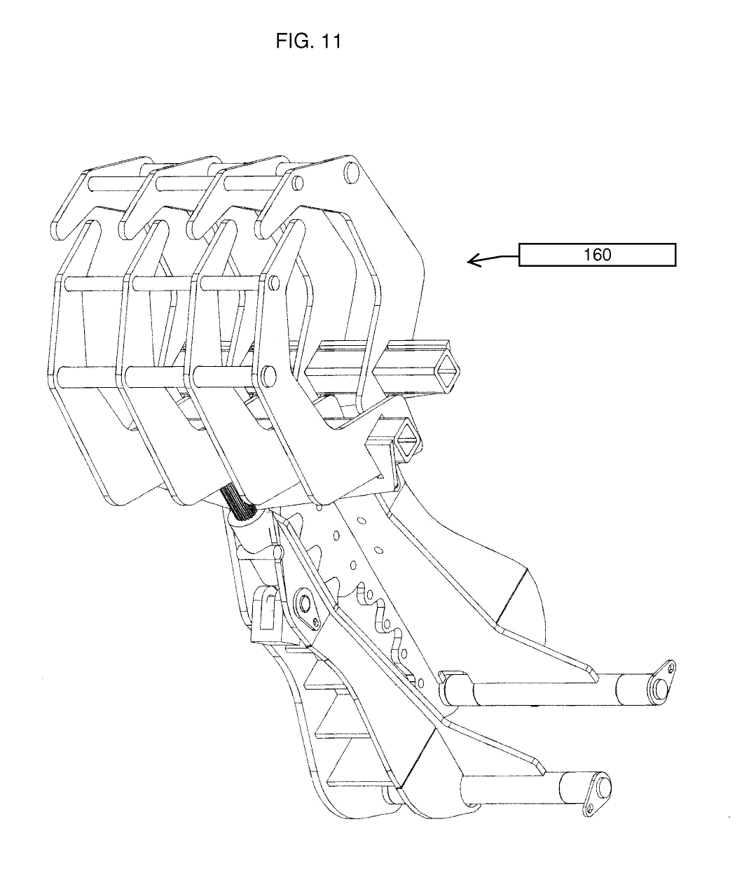

Referring to FIG. 2, as discussed above, the plate element 30 is configured to allow a variety of different attachments to be removably mounted on the jaw, for example shearing blades if the jaw is to be used for shearing trees. Plate element attachment points 36, in the form of holes, are provided for this purpose. These attachment points may be used to directly bolt an attachment onto the plate element. A universal attachment device 46, such as a locking, splined tube mount, allows for attachments to be quickly applied and removed as needed. The universal attachment device 46 will be discussed further below. Support element attachment points 37, also in the form of holes, are located on the vertical support element 38 (FIG. 11). These attachment points may not be used with all attachments, but allow for even more secure mounting, particularly when significant levering forces will be applied to the attachment during use, e.g., when an attachment extends significantly beyond the distal end of the jaw and thus acts as a cantilever.

As mentioned above, the device may include universal attachment device 46, shown as a receiver, that has a splined inner diameter 100 (FIG. 2) for the purpose of allowing rapid integration of a variety of activity-specific attachments, examples of which are shown in FIGS. 11, 12, 13, and 14. The universal attachment device 46 (FIG. 2) when configured with a splined inner diameter 100 allows attachments that include complementary splined shafts 102 to be positioned in a number of different rotational orientations with respect the jaw elements 21. Examples of attachments that benefit from being positioned in different rotational orientations for different tasks will be discussed below.

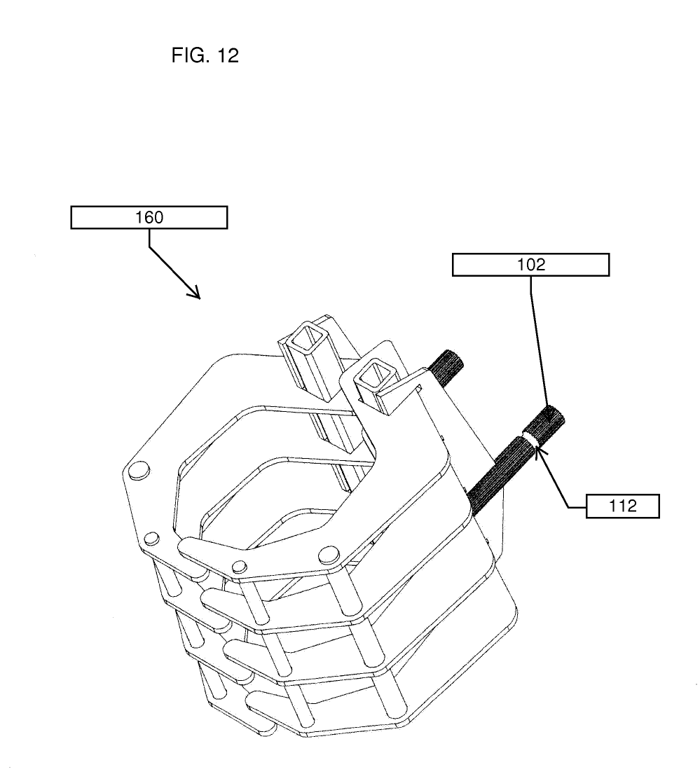

The universal attachment device 46 (FIG. 2) features a locking mechanism 110 which, when engaged, ensures a secure interface with the attachment to prevent the attachment from dislodging/disconnecting during use. When the locking mechanism 110 is disengaged, the attachment can be easily removed. The locking mechanism 110 can be a spring-loaded device that integrates with a complementary groove 112 (FIG. 12). Such locking mechanisms are well known in the art.

In some cases, the jaw may be used to grasp materials, with or without an attachment in place. This grasping is assisted by the structure of the plate elements, which includes a plurality of radiused teeth 34 that are sequentially positioned in the horizontal plane along the medial edge of the plate element 30. The radiused shape of these teeth allows them to grasp even relatively delicate objects (e.g., pumpkins) without damage, and prevents build-up of debris between the teeth.

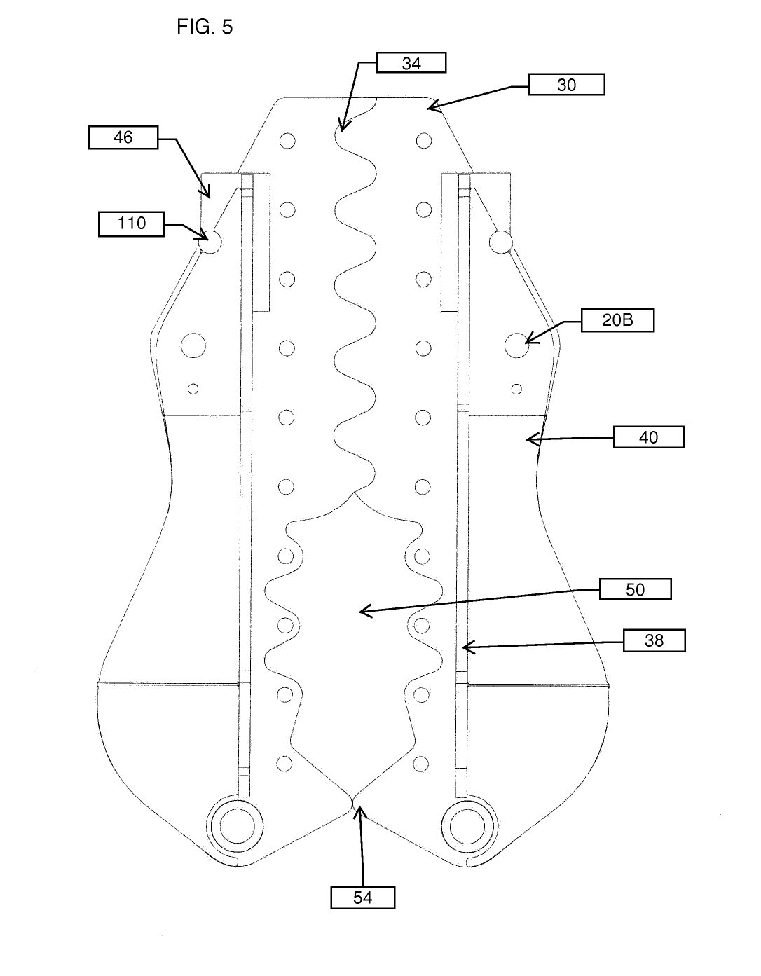

Referring to FIG. 5, the plate elements 30 also define an open area or “throat” 50 in the portion of the jaw 20 that is proximal to the frame. This open area can be formed, as shown, by reducing the size of the radiused teeth 34 in this area, or in any other desired manner. The open throat serves several purposes, including allowing trees or other objects of appropriate diameter to be grasped and retained, or, alternatively, to allow shearing blades or other cutting implements to be exposed in the throat area. When the jaw is to be used to accumulate sheared objects, e.g. trees, the shearing blades would be moved distally with respect to open area 50, e.g., so that the blades extend beyond the distal end of the jaw and do not cover the open area 50. This configuration allows the sheared objects to be grouped and grasped in the open area allowing for easier manipulation. Depending on the size of the jaw and its intended uses, the open area 50 may be, for example, from about 4 inches to about 60 inches long (measured along the long axis of the jaw), and from about 4 inches to about 42 inches wide (measured at the widest point perpendicular to the long axis of the jaw).

The plate elements 30 are also configured to allow material in the open area 50 to be easily cleared when the jaws are opened. Ejector/accumulator triangle members 54 are located at the proximal end of the jaw element, nearest the frame 8, and are shaped to push material forward as the jaw opens.

Referring to FIG. 6, the jaw element includes a truss feature, as discussed above. The upper support element 40 serves as an upper attachment point for the multiple truss elements 42, 43, 44, and 45. The upper support element 40 features a distal portion that is generally parallel to the jaw element 30, a central portion that inclines distal to proximal with respect to the device frame 8 so that the distance increases between the upper support element 40 and the jaw element 30, and a proximal portion that is generally parallel to the jaw element 30. Referring to FIGS. 2 and 6, the relative dimensions of the truss elements differ with respect to their location on the jaw element 30. Generally, the length and height of the truss elements increase distally to proximally, to accommodate the greater forces that will be exerted on the proximal area of the jaw element.

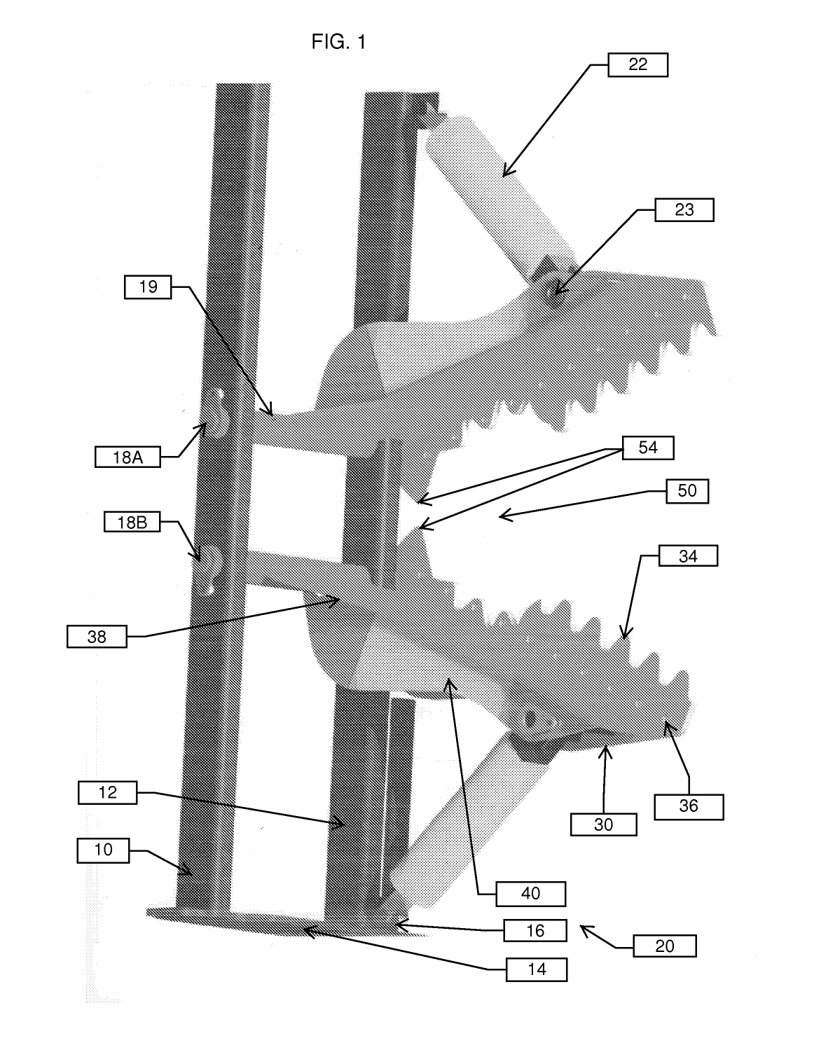

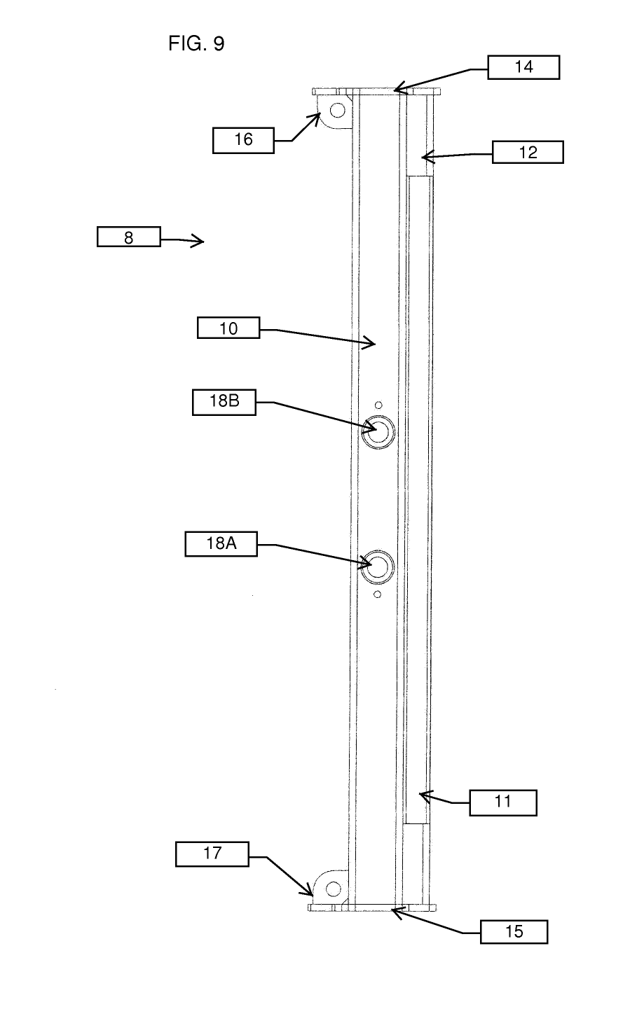

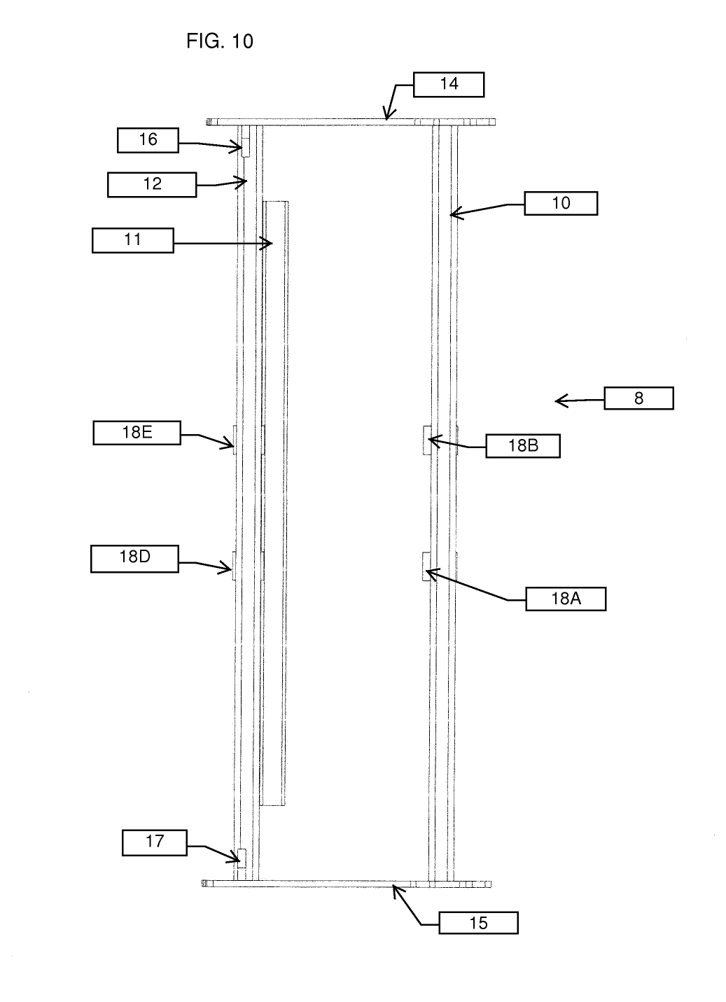

Referring to FIG. 9 and FIG. 10, the frame 8 is configured generally in a rectangular shape and includes an upper frame member 10, a lower frame member 12, a left side member 14, and a right side member 15. The size of the frame is scaled to allow the frame to be mounted on a desired piece of heavy equipment. A left cylinder frame mount 16 is positioned in the horizontal plane on the left side of the lower frame member 12 where the left side vertical member 14 and lower frame member 12 intersect. A right cylinder frame mount 17 is positioned in the horizontal plane on the right side of the lower frame member 12 where the right side vertical member 15 and lower frame member 12 intersect. In a preferred embodiment, the right cylinder frame mount 17 and left cylinder frame mount 16 serve as attachment points for force applying elements, for example a hydraulic ram, which are configured to operate independently. Two pin bosses 18A and 18B are configured in the upper frame member 10 and pin bosses 18C and 18D are configured in the lower frame member 12 are configured so that two hollow pivot pins 19 can pass from the upper frame member 10 to the lower frame member 12 in the vertical plane generally parallel to each other. These pivot pins attach the jaw to the frame, as shown in FIG. 1A. Greaseless, self-lubricating bearings (not shown) are provided inside pivot pins 19. These bearings are preferably Polygon Composite's PolyLube® composite bearings. Using greaseless bearings provide a long life cycle and reduce or eliminate maintenance concerns. In some embodiments, the pivot pins have an outer diameter of from about 1 inch to about 5 inches, with the diameter being scaled to the overall size of the jaw. Protection member 11 is positioned on the lower frame member 12 to provide a protected path for hydraulic hoses (not pictured) that run between the force applying elements 22, for example hydraulic rams, and the heavy machine the device is attached.

As mentioned previously, the splined shaft-receiver interface allows the attachments to be positioned in a plurality of orientations increasing the versatility of the attachment.

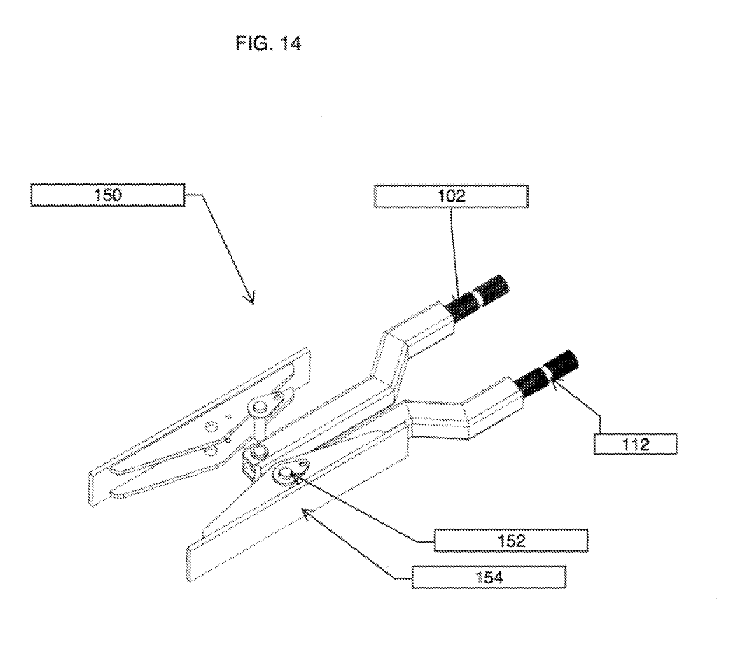

For example, referring to FIG. 14, a clamp attachment 150 can grasp either in the inside or outside of an object. The clamp attachment 150 feature a hinge 152 that would allow the pressure surface 154 to adapt alignment of the clamp to the object being manipulated, e.g. the inner surface of a large pipe. By removing the clamp attachment from the jaw and rotating its arms 180 degrees, the clamp attachment can be positioned to either slide into a pipe and expand outward to grasp the pipe from inside, or to clamp the pipe from the outside.

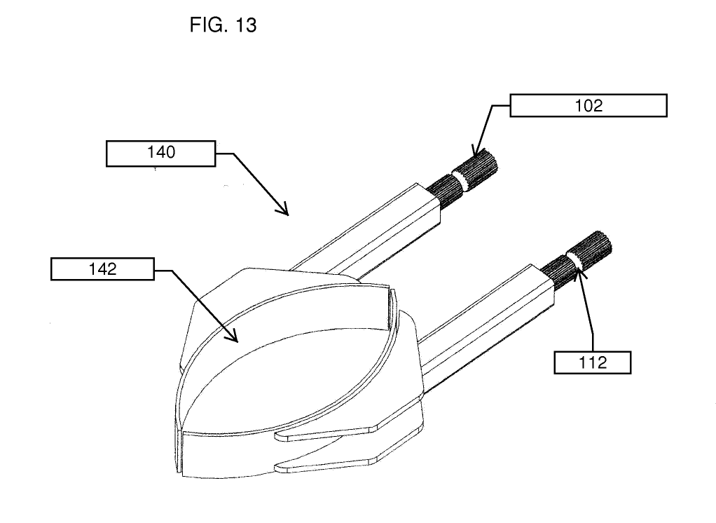

Referring to FIG. 13, a barrel/cylinder clamp 140 with a radiused surface 142. The radiused surface 142 would allow the applied force to be more evenly distributed over the item being manipulated, e.g. a barrel, tree root ball, etc. As another example of the use of the splined attachment of the clamp to the jaw, in this case the rotational orientation of the two sides of the clamp can be adjusted to allow the clamp to cradle an irregularly shaped or rounded object such as a burlap wrapped root ball, or in a different rotational orientation to grasp a cylindrical object, such as a nursery pot, from the sides.

Referring to FIGS. 11, 12, an attachment can be configured as a grapple 160. As discussed above with reference to FIGS. 10 and 11, this attachment can be mounted on the jaw in a variety of rotational orientations to adapt it for use with different materials and/or in different applications.

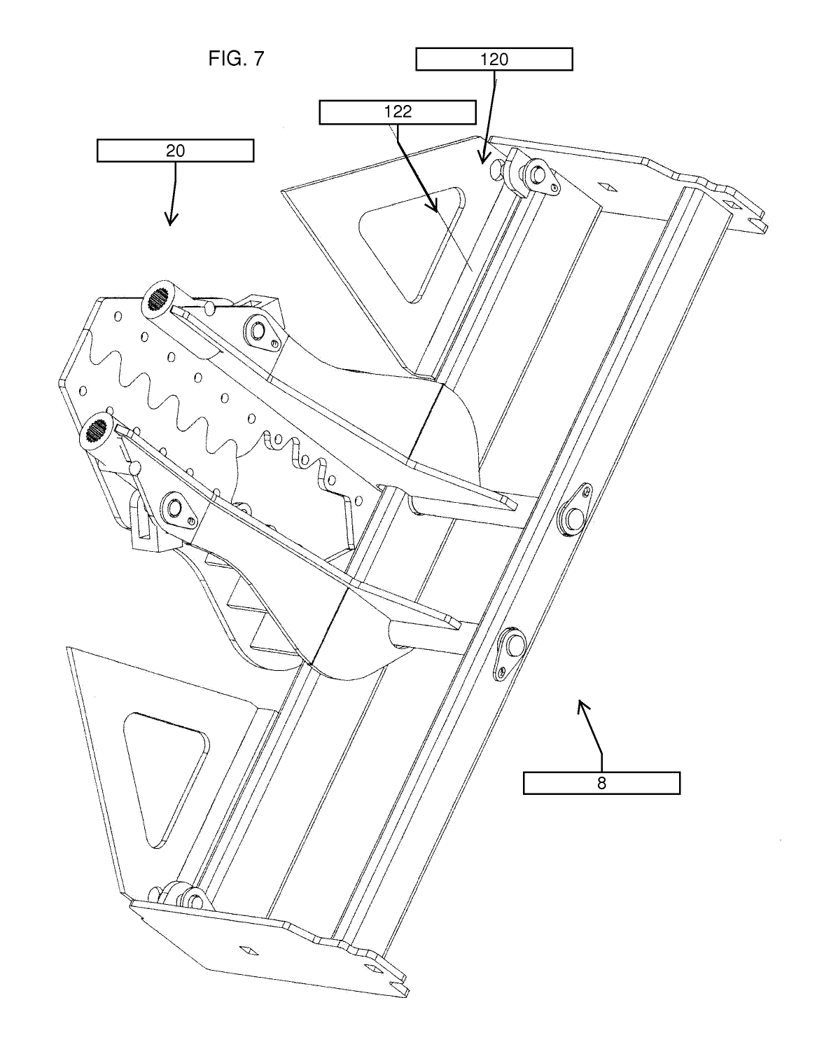

Referring to FIG. 7, the jaw can include a skid plate 120 that is designed to be substantially parallel with the lower surface of the lower frame member 12. Preferably, the jaw includes two skid plates 120, one on each end of the frame 8. An opening 122 in the skid plate 120 allows accumulated dirt or debris to be cleared of the device. The skid plate 120 would ensure that the device could be easily aligned with the ground surface while providing protection for the force applying elements 22 (FIG. 3).

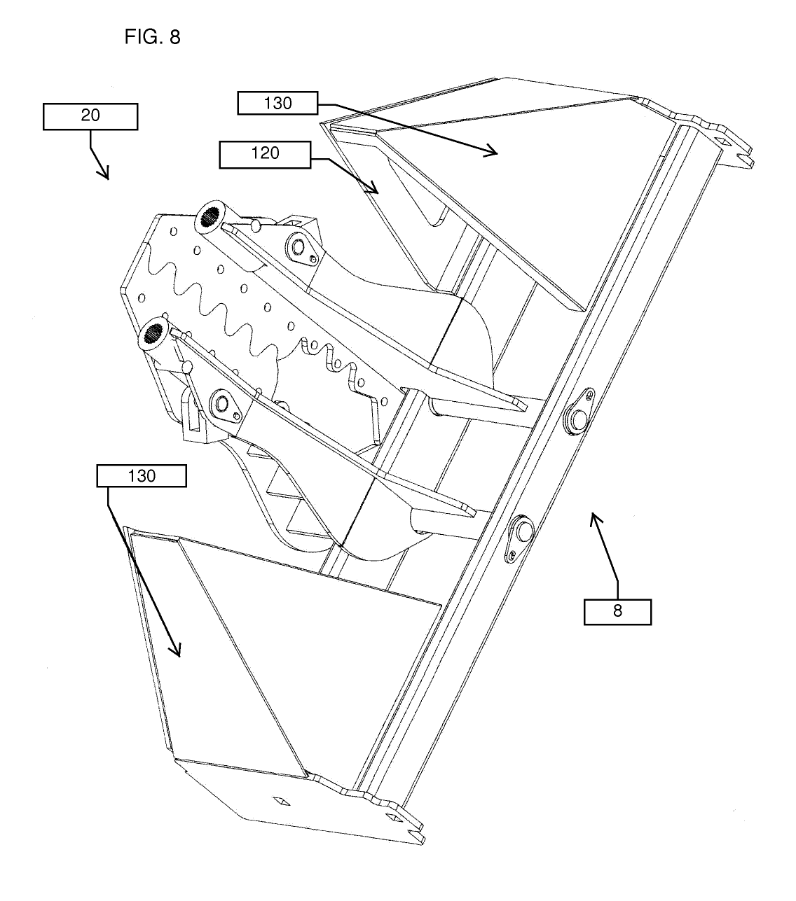

Referring to FIG. 8, a shroud 130 is configured to further protect the force applying elements 22 (not shown) from damage occurred from accidental impact.

Preferably, the dimensions of the device would be proportional to the size, horsepower and weight of the heavy machinery utilizing it. This would allow the device components to be appropriately scaled to fully accommodate the abilities of the heavy machinery while not being over burdened which could lead to premature device failure. For example, a device scaled to work with a small skid steer weighing 1200 lbs. would feature smaller components than a device scaled to work with a large front loader weighing 50,000 lbs. As an example, devices of various sizes would in some embodiments have the following dimensions (measured as discussed above):

Machine Wgt (lb)

| | 1,200- | 4,000- | 12,000- | 30,000- |
|---|---|---|---|---|
| | 3000 | 10,000 | 25,000 | 60,000 |
| Plate thickness (in) | 0.375 | 0.625 | 1.00 | 1.50 |
| Jaw Length (in) | 18 | 30 | 38 | 50 |
| Jaw Opening (in) | 18 | 30 | 38 | 50 |
| Throat Length (in) | 4 | 12 | 24 | 38 |
| Throat Width (in) | 4 | 9 | 18 | 28 |
| Pivot Pin OD (in) | 1.13 | 1.44 | 2.50 | 3.50 |

### Other Embodiments

A number of embodiments have been described. Nevertheless, it will be understood that various modifications may be made without departing from the spirit and scope of the disclosure.

For example, alternative embodiments of the device feature only one articulating jaw element while the opposing jaw element is fixed in a predetermined position. This configuration would be more economical while still maintaining much of the functionality of the preferred configuration.

In addition, the open throat feature could be eliminated so that the radiused triangular protrusions extend from the distal to proximal aspect of the jaw elements without dimensional changes.

In some embodiments, a guard is provided on the top member of the frame. The guard extends vertically to protect the heavy machine and the operator of the machine to which the device is attached from accidental debris impact during use. The guard would be designed to resist deformation or destruction upon impact. Such guards are well known in the heavy equipment art.

An alternative embodiment could feature a rotation option that would allow the jaw to rotate, as a unit, 360° about the long axis of the jaw via an interface between the machine mount and the jaw. This feature could be hydraulically or manually actuated.

In some embodiments the splined, locking receivers may be disposed on the attachments and the complementary splined shafts may be disposed on the jaw elements.

Some embodiments may feature a splined receiver configured with multiple locking devices. The locking devices could be automatically, hydraulically or manually engaged.

In some embodiments, the attachment receiver could be designed to be bolted on to the device utilizing the attachment holes mentioned previously.

In an alternative embodiment, the jaw could be configured to directly attach to the heavy machinery, e.g. by pinning. This method of attachment would not allow for the rapid implement interchanging that is possible with a universal quick attachment typically used on a skid steer, but would be acceptable in some applications.

Accordingly, other embodiments are within the scope of the following claims.

What is claimed is:

1. A device comprising:
a mount configured to be attached to a piece of heavy equipment,
a jaw comprising a pair of jaw elements, at least one of which is pivotally attached to the mount,
each jaw element including a plate element disposed in the horizontal plane, each plate element having a plurality of attachment points configured to allow an attachment to be removably attached to the plate element, and
a force applying element, configured to, when actuated, pivot at least one of the jaw elements.

2. The device of claim 1 wherein teeth are configured along the entire length of one edge of each plate element.

3. The device of claim 2 wherein at least some of the teeth are radiused.

4. The device of claim 2 wherein the teeth are configured to allow a portion of the plate elements to completely fit together when the jaw is closed.

5. The device of claim 4 wherein the teeth are configured to allow a second portion of the plate elements to remain spaced from each other when the jaw is closed, defining an open area between the plate elements.

6. The device of claim 1 wherein the plurality of attachment points comprise multiple holes extending through the plate element in the horizontal plane along at least a portion of the length of the plate element.

7. The device of claim 1 wherein each jaw element comprises a support element on which one of the plate elements is mounted.

8. The device of claim 7 wherein each support element includes a vertical member having multiple holes configured to serve as vertical attachment points for the device.

9. The device of claim 1 wherein the attachment is selected from the group consisting of shearing blades, carriers, crushers, wood splitters, snow plows, sod-unrollers, digging tools, ditching tools, and grading tools.

10. The device of claim 1 wherein a universal attachment device is mounted on the plate element.

11. The device of claim 10 wherein the universal attachment device is removably mounted via the attachment points.

12. The device of claim 10 wherein the universal attachment device comprises a splined receiver element.

13. The device of claim 1 wherein the jaw elements are configured to allow for a open area between the jaw elements near the jaw pivot point(s) when the jaw elements are closed.

14. The device of claim 1 wherein the jaw is configured so that no aspect of the jaw extends below the lower surface of the plate elements.

15. A device comprising:
a mount configured to be attached to a piece of heavy equipment,
a jaw comprising a pair of jaw elements, at least one of which is pivotally attached to the mount,
each jaw element including a plate element disposed in the horizontal plane, and
a force applying element, configured to, when actuated, pivot at least one of the jaw elements so as to bring opposing surfaces of the plate elements closer together,
wherein the plate elements are configured so that when the plate elements close together the plate elements define an open area adjacent the pivot point of the jaws.

16. The device of claim 13 wherein the jaw is configured so that no aspect of the jaw extends below the lower surface of the jaw elements.

17. The device of claim 13 wherein the open area is generally oval.

18. The device of claim 13 wherein the plate elements comprise teeth that extend into the open area.

19. The device of claim 13 wherein the plate elements include generally triangular protrusions that extend horizontally into the open area to define an end of the open area proximal to the mount.

20. The device of claim 13 wherein the triangular protrusions are dimensioned to eject material in the open area from the jaw as the jaw members open.

21. A device comprising:
a mount configured to be attached to a piece of heavy equipment,
a jaw comprising a pair of jaw elements, at least one of which is pivotally attached to the mount,
each jaw element including a truss structure comprising
an upper support member and a lower support member connected by multiple truss webs, and
a force applying element, configured to, when actuated, pivot at least one of the jaw elements.

22. A method comprising:
shearing the trunk of a first tree using a jaw that is mounted on a piece of heavy equipment, the jaw having opposed shearing blades that are mounted on jaw elements, the jaw elements being configured so that when the shearing blades close together an open area is defined at the end of the jaw proximal to the piece of heavy equipment;
allowing the trunk of the first sheared tree to move into the opening; and
shearing a trunk of a second tree while the first sheared tree remains in the opening.

23. The method of claim 19 further comprising allowing the trunk of the second sheared tree to move into the open area adjacent the trunk of the first sheared tree.

24. The method of claim 20 further comprising shearing the trunk of a third tree while the first and second sheared trees remain in the opening.

25. The method of claim 20 further comprising using the jaw to move the first and second sheared trees to a desired location.
